(19) United States
(12) Patent Application Publication
(10) Pub. No.: US 2005/0207631 A1
(43) Pub. Date: Sep. 22, 2005

(54) Method of image analysis

(76) Inventors: Harald Martens, Holmasu, 3, N-1440 (NO); Geir Torheim, Nydalen (NO); Frank Westad, Arildsvingen (NO)

Correspondence Address: Amersham Health Inc, Ip Department, 101 Carnegie Center, Princeton, NJ, 08540, US

(21) Appl. No.: 10/504,881

(22) PCT Filed: Feb. 14, 2003
(86) PCT No.: PCT/NO03/00056

§ 371 Date: May 13, 2005

(30) Foreign Application Priority Data
Feb. 15, 2002 (NO) 20020780

(51) Int. Cl. G06K 9/00

(52) U.S. Cl. 382/131

(57) ABSTRACT

The present invention relates to methods for analysing image data acquired in magnetic resonance tomography and the use of said methods for the identification of pathological tissue, preferably tumour tissue.

### METHOD OF IMAGE ANALYSIS

The present invention relates to a method for analysing image data acquired in magnetic resonance tomography and the use of said method for the identification and characterisation of pathological tissue, preferably tumour tissue.

In a typical medical application of magnetic resonance imaging (MRI), a patient is placed within the bore of a large, donut-shaped magnet. The magnet creates a static magnetic field that extends along the long (head-to-toe) axis of the patient's body. An antenna (e.g. a coil of wire) is also positioned within the bore of the large magnet, and is used to create an oscillating radiofrequency field that excites the nuclei of a specific type of atom (commonly hydrogen) in the patient's body into oscillation. The oscillating field is then turned off, and antennas are used to detect the emitted radiofrequency signal from the body. The signals are then transformed into images by using a suitable method, like the Fourier transform. The intensities in MR images reflect a complex combination of different factors like proton density, T₁ and T₂ relaxation times, diffusion, and flow.

In order to improve the image contrast, contrast agents are often used in MRI. The contrast agent works by changing the T₁, T₂ and/or T₂*relaxation times, thereby influencing the contrast in the images. Information related to perfusion, permeability and cellular density as well as other physiological parameters can be obtained by observing the dynamic behaviour of a contrast agent. A time series of MR images of a specific body region is acquired before and immediately after application of a contrast agent to the body (dynamic imaging). Said image series can be combined with other images, like texture derived images, images with different T₁-, T₂- or proton density weighting, diffusion images, magnetisation transfer images or spectroscopic images. The complete set of images constitutes a set of image data describing anatomical and physiological features of the imaged body region.

Said complete set of images can be visually interpreted but due to the amount of data such a set of images is often quite complex. Thus, visual interpretation is difficult or, in some cases, even impossible. In order to overcome these problems and to extract the wealth of information that MR images contain, image analysis techniques are used such as multivariate image analysis (MIA) and multivariate image regression (MIR). By calculating a regression model between several images of the same site acquired under different conditions, estimations can be made of which tissues have similar characteristics and/or properties. Some of the principles of multivariate image regression on MR images and their use in clinical research are described in “Multivariate image regression and analysis”, by Grahn and Saaf, Chemometrics and Intelligent Laboratory Systems 14, (1992), 391-396.

In U.S. Pat. No. 5,311,131 pattern recognition is used for determining the similarity between a known primary tumour and a remote lesion of an unknown type. A MR imaging apparatus is used to produce a “training set” of images of the known tumour. The same apparatus is also used to provide a set of test samples of a region of the body being scanned for secondary tumours. Similarity data is then provided to indicate the degree of similarity between the test sample and the training sample by preferably determining the Euclidian distance between the training set and each member of the test set. The disadvantage of this method is that it is based on defining a training set from a known tumour in the image which in most cases is inherently inhomogeneous, such that neighbouring pixels within the tumour image can in reality exhibit quite different behaviour. Another disadvantage is a lack of proper validation of the constructed classes and the lack of physiological information in the data set being processed.

Principle Component Analysis (PCA) is a statistical method for multivariate analysis, which attempts to maximise the “information content” of data. Data are transformed such that they are given in relation to a number of orthogonal principal components, rather than the original parameters. The first principal component accounts for the maximum variance in the data set, the second principal component is the linear combination which has maximum variance (information content) while being uncorrelated and orthogonal to the first. Subsequent principal components are those linear combinations that have maximum variance under the constraint of being orthogonal to all previous components. In this way the redundancy which is often apparent in the acquired images is removed resulting in a condensed information content.

Schmiedl et al, Magnetic Resonance in Medicine 4, (1987), 471-486 describe the use of PCA for the image display of brain lesions. PCA is only applied to a pre-selected region of interest (ROI) and the obtained data are then directly applied to all pixels within the image without further refinement, validation or classification. The disadvantage is that such an application of PCA data leads only to models with relatively low accuracy.

Maas et al., Journal of Magnetic Resonance Imaging 7(1), (1997), 215-219 describe the measuring of regional cerebral blood volume by dynamic susceptibility contrast MR imaging in Alzheimer's Disease. The acquired image was divided in several regions and mean values were calculated for each region resulting in a reduced amount of data compared to the amount of image data. PCA was then applied to said reduced amount of data. The disadvantage is that such an application of PCA leads only to models with relatively low accuracy as by calculation of mean values for each region, the resulting data will lack information about heterogenicity of said regions.

We have now surprisingly found a method of analysing image data comprising
a) generating data in an image space by acquisition of multichannel data in MR tomography of an human or non-human animal body where at least one subset of the channels describes the dynamic behaviour of a MR contrast agent which has been previously administered to said body,
b) defining a least one region of interest in the image space (ROI)_{I},
c) generating data in a score plot space by transforming the image data generated in a) or the image data corresponding to (ROI)_{I} into score plot data using multivariate image analysis,
d) determining the region of interest in the score plot space (ROI)_{S} which corresponds to (ROI)_{I},
e) selecting relevant data points in connection with the (ROI)_{S}, and
f) mapping the data points selected in e) into an image space and thereby identifying image data having a property similar to that of (ROI)_{I}.

In step a) of the method according to the invention, data in an image space are generated by acquisition of multichannel data in MR tomography of an human or non-human animal body where at least one subset of the channels describes the dynamic behaviour of a MR contrast agent which has been previously administered to said body.

According to the invention, MR tomography, preferably in vivo MR tomography is used to acquire multichannel data of a human or non-human animal body, preferably a human or mammalian animal body, to which a contrast agent has been previously administered. The multichannel data may be two or three-dimensional, preferably two dimensional, as this has been found to be more convenient. The multichannel data are used to generate data in an image space, e.g. to create MR images based on said data.

The term “channel” as used herein refers to a set of parameters having an influence on the acquired data and thereby on the MR images based on said data. Such parameters may for example be recovery time (TR) and echo delay time (TE) as well as other instrument settings or time. For example, T₁-weighted images or T₂-weighted images are collected using a set 1 of parameters (channel 1) followed by collecting images using a set 2 of the same parameters (channel 2) and so on. Since image data are analysed according to the method of the invention without the need to be visualised, the use of multiple channels does not cause difficulties in understanding said data.

According to the invention, at least one of the subsets of the channels describes the dynamic behaviour of a contrast agent which has been previously administered to a human or non-human animal body. Preferably, the dynamic behaviour of a contrast agent is followed up by acquiring a first series of multichannel data and MR images based on said data of a body region before administration of the contrast agent followed by acquiring a second series of multichannel data and MR images based on said data of the same body region after a contrast agent has been administered.

The choice of the MR contrast agent is dependent on what kind of information one wish to obtain from the MR tomography.

Preferred MR contrast agents are extracellular fluid (ECF) MR contrast agents and blood pool MR contrast agents. If higher sensitivity is required and/or a first scan is going to be conducted, ECF contrast agents are preferred. If the method according to the invention is used to gain information about tumour perfusion or angiogenesis, blood pool contrast agents are preferred.

ECF contrast agents rapidly distribute throughout the extracellular fluid space (the vascular bed and the interstitium) and do not enter the intracellular compartment. As ECF contrast agents, preferably paramagnetic inorganic salts, metal complexes or paramagnetic metal chelates are employed. Particularly preferably, paramagnetic metal chelates are used, especially preferably GdDTPA-BMA (Omniscan™ from Amersham Health).

The term “blood pool agent” as used herein refers to a magnetic (e.g. paramagnetic, ferromagnetic, ferrimagnetic or superparamagnetic) material, capable of reducing T₁ and/or T₂/T₂′ of water protons and which, if administered into the vascular space, does not significantly leak out into the interstitium during the time course of the MR tomography procedure, i.e. it is essentially confined to the vascular space until excreted or metabolised. Particularly preferred contrast agents according to the invention are superparamagnetic iron particles.

In step b) according to the method of the invention, a region of interest (ROI) is defined in the image space (ROI)_{I}. A (ROI)_{I} can for example be an area on the MR image corresponding to a tumour, a lesion or any other pathological alteration which can be detected on the MR images. Preferably, the (ROI)_{I} is chosen as such that it includes the region(s) of the pathologically altered area which show(s) the maximal enhanced contrast. The (ROI)_{I} is preferably drawn by using semi-automatic or automatic ROI tools. The (ROI)_{I} can be of any shape. In most cases it is not necessary to draw a (ROI)_{I} with an irregular shape, a rectangle or an ellipse will usually be sufficient.

In step c) of the method according to the invention, the image data generated in step a) or the image data corresponding to (ROI)_{I} are transformed into score plot data using multivariate image analysis.

Multivariate image analysis according to the invention is preferably carried out with bilinear methods or multi-way extensions of bilinear methods. Preferred bilinear methods are principal component analysis (PCA), partial least squares regression (PLSR), independent component analysis (ICA) or principal component regression (PCR). Preferred multi-way extensions of bilinear methods are PARAFAC, Tucker, Procrustes or multi-way PLSR. Particularly preferred multivariate image analysis according to the invention is PCA and PLSR, especially particularly preferred is PCA.

According to the invention, PCA is preferably applied to a matrix X. Said matrix X is the unfolded 3-dimensional data matrix of the multichannel data acquired in step a) of the method according to the invention. The dimensions of said matrix X are [(nv·nh)·x] with x being the number of channels and (nv·nh) being the number of pixels within one channel (see also FIG. 1). PCA is used to solve eigenvalue-eigenvector pairs from the matrix X. This mathematical operation is for example described in Johnson and Wichern, Principal Components in: Johnson (ed), Applied multivariate statistical analysis, Englewood Cliffs, N.J., Prentice Hall, 1992, 356-395. At least a part of the principal components (PCs), preferably the PCs which show the highest information content, is used to generate a score plot. The score plot is preferably a two-dimensional score plot generated from two different PCs, for example PC1 and PC2 or PC1 and PC3. Preferably, more than one score plot is generated. In the score plot space pixels from the image space with similar properties and/or characteristics over multiple channels do form clusters. Hence, these clusters are decoupled from the image space.

In another preferred embodiment, partial least squares regression (PLSR) is used as the multivariate image analysis in the method according to the invention. In general, regression is a way of relating two blocks of data A and B, wherein A is a matrix of independent variables and B is a matrix of dependent (response) variables. According to the invention, PLSR is preferably applied as a discriminant method, such that the image data are regarded as A and the information (anatomic, diagnostic, morphologic, etc.) derived from said image data is put in the matrix B. For cases with several sets of (instrumental) measurements, such as T₁ and T₂*-weighted data, so-called hierarchical or multi-block PLSR is preferably applied as the sets which are regarded as several A data (A1, A2, . . . ) may have different number of variables. Therefore, they are preferably modelled separately or with different weights for each set. The scores from the separately modelled PLSR models are than combined in a final PLSR model. The mathematical operation for PLSR is described in H. Martens et al., Multivariate Calibration, John Wiley & Sons New York, 1991.

Either the whole image data generated in step a) or only the image data corresponding to (ROI)_{I} are transformed to generate score plot data using multivariate image analysis. If only the image data corresponding to (ROI)_{I} are transformed, the transformation as well as subsequent steps d) to f) are preferably repeated on the whole image data as well at a later time. By carrying out the method of the invention as described above, a higher resolution of the ROI area in the score plot space can be obtained which is favourable if there are many data points in the vicinity of the data points belonging to the ROI.

In step d) according to the method of the invention, the region of interest in the score plot space (ROI)_{S} which corresponds to (ROI)_{I} is determined. Said determination is preferably done by traversing a data structure containing for each point in the score plot space information on pixel position in the image space.

In step e) according to the method of the invention, relevant data points in connection with the (ROI)_{S} are selected. The term “relevant data points” herein preferably refers to data points which can be found in the score plot space close to the data points of the (ROI)_{S}. Pixels from the image corresponding to tissue having similar properties/characteristics to those of the (ROI)_{I} will be found in the score plot space close to the (ROI)_{S} regardless of their actual position in the image itself. Thus, if the (ROI)_{S} corresponds to a tumour, other data points clustering nearby may also relate to tumour tissue in another part of the image.

In order to identify the corresponding pixels in an image, the data points selected in e) are mapped into an image space in step f) according to the method of the invention. This is preferably done by traversing the previously mentioned data structure.

Another aspect of the invention is a method of analysing image data comprising
a) generating data in an image space by acquisition of multichannel data in MR tomography of a human or non-human animal body where at least one subset of the channels describe the dynamic behaviour of a MR contrast agent which has been previously administered to said body,
b) generating data in a score plot space by transforming the image data generated in a) into score plot data using multivariate image analysis
c) defining at least one region of interest in the score plot space (ROI)_{S} and
d) determining the region of interest in the image space (ROI)_{I} which corresponds to (ROI)_{S}.

This method is preferred if the score plot shows one or more outlayers, i.e. regions with data points which show another behaviour than the rest of the score plot data points. In a preferred embodiment, regions of interest are defined in the image space and the score plot space, respectively and the corresponding region of interest is determined in the image space and the score plot space, respectively.

The methods according to the invention will be illustrated in the following embodiment: A patient having a known tumour undergoes MR tomography evaluation. A contrast agent is administered to the patient, multichannel data are acquired before and after the contrast agent's administration and images based on these data are created. The tumour is identified on one or more of the images and a ROI is defined in the image space corresponding to said tumour. Subsequently, the corresponding ROI in the score plot space is determined and relevant data points in connection with the (ROI)_{S} in the score plot space are selected. The data points are mapped into the image space allowing the identification of pixels in the image showing the same or similar properties/characteristics as the pixels belonging to the tumour. It is thereby possible to identify tumour tissue or tumour satellites which can not be identified on an MR image by using visual assessment alone.

The image space in step f) can be the same or a different image space than in step a). In a preferred embodiment, the image space is the same image space than in step a). In another preferred embodiment, the image space in step f) is of images acquired at a later time than the images in step a). For example, a patient undergoes MR tomography at a time 1 and image data are analysed according to the methods of the invention. The same patient undergoes MR tomography at time 2 later than time 1 and the image data acquired at time 2 are analysed using the information obtained at time 2 and/or at time 1 by the methods according the invention. As such, the methods of the invention are for instance suitable to observe tumour growth or regression in one patient. In another preferred embodiment, the image space in step f) is of images acquired from a different human or non-human animal body than the images in step a). For example, a patient 1 undergoes MR tomography and image data are analysed according to the methods of the invention. A different patient 2 undergoes MR tomography and the image data acquired are analysed using the information obtained from patient 1 by the methods according the invention. As such, the methods of the invention are for instance suitable to screen patients for a special type of tumour. If the image space in step f) is a different image space than the image space in step a), the multichannel data should preferably have been obtained in the same or a similar manner.

In a preferred embodiment of the method according to the invention, noise reduction methods and/or methods for motion estimation are applied to the data acquired in step a). Susceptibility artefacts, breathing and in general low signal to noise ratio can be compensated by applying methods for noise reduction to the data acquired in step a). Preferably, methods which are described by Godtliebsen et al., IEEE Trans. Med. Imaging 20, 2001, 3644 and by G. Torheim et al. IEEE Trans. Med. Imaging 20, 2001, 1293-1301 are applied. Artefacts arising from motion can be compensated by applying methods for motion estimation to the data acquired in step a). Preferably, data acquired in a) are blurred by convoluting them with a Gaussian filter mask, as described in: J. C. Russ, The Image Processing Handbook 1992, CRC Press Inc, N. W., Boca Raton, Fla., page 57-60.

In a preferred embodiment of the invention, data in the score plot space belonging to the (ROI)_{S} are used to create a class model. The class model can be created by using all data belonging to the (ROI)_{S} or a only a certain number of data. In a preferred embodiment, only a certain number of data belonging to the (ROI)_{S} are used to create the class model. This is because not all the channels that are included in the matrix X the multivariate analysis is applied to contain equally useful information. Thus, a number of redundant data are generated by performing multivariate analysis and plotted in the score plot space. In PCA for example, the first principal component accounts for the maximum variance in the data set, the second principal component is the linear combination which has maximum variance (information content) while being uncorrelated and orthogonal to the first. Those two principal components contain the maximum information content. Subsequent principal components contain minor information content. In order to find the optimal number of components for a class model and thereby the optimal dimensionality of the model, the data in the score plot space belonging to the (ROI)_{S} are preferably validated to create a class model.

Hence, in a particularly preferred embodiment of the invention, data in the score plot space belonging to the (ROI)_{S} are validated to create a class model. Preferably, validation is carried out using unsupervised cross validation. The principle of unsupervised cross validation is to remove some objects from the total number of objects, make a sub-model on the remaining objects and project (or predict in the case of regression) the objects that were removed.

In a preferred embodiment of the invention, the class model created from the data in the score plot space belonging to the (ROI) is used to classify other data points in the score plot space, thereby identifying data points having the same or similar properties/characteristics as data points belonging to the (ROI)_{S}. A preferred method for said classification is soft independent modelling of class analogies (SIMCA) classification. The basis for a SIMCA classification is one or more separate class models, e.g. for pixels belonging to the (ROI)_{I}. The SIMCA method classifies pixels based on two criteria, the distance from the model centre (leverage) and the distance to the model itself (residuals). The critical limit for pixels belonging to a specific class is preferably determined using Hotelling statistic as described in Esbensen et al. (eds), Multivariate Analysis in Practise, 1994, CAMO ASA Trondheim, Norway.

Another preferred method for validation is jack-knifing. Jack-knifing is a re-sampling method where models are computed by repeated sub-sampling form the total number of observations until each observation has been omitted in one of the sub-models. Said method has traditionally been used to estimate uncertainties in model parameters but can also be used to estimate prediction and classification error in terms of cross-validation.

Thus, in a particularly preferred embodiment the method of analysing image data comprises:
a) generating data in an image space by acquisition of multichannel data in MR tomography of an human or non-human animal body where at least one subset of the channels describes the dynamic behaviour of a MR contrast agent which has been previously been administered to said body,
b) defining a least one region of interest in the image space (ROI)_{I},
c) generating data in a score plot space by transforming the image data generated in a) or data corresponding to (ROI)_{I} into score plot data using multivariate image analysis,
d) determining the region of interest in the score plot space (ROI)_{S} which corresponds to (ROI)_{I},
e) selecting relevant data points in connection with the (ROI)_{S},
f) creating a class model from at least a part of the data points belonging to (ROI)_{S},
g) applying the class model to classify data points in the score plot space, and
h) mapping the classified data points into a image space and thereby identifying image data having properties similar to that of (ROI)_{I}.

In a preferred embodiment, the ROI defined in the image space corresponds to pathological tissue, preferably to a tumour and the methods of the invention are used to identify image data (pixels) having similar properties/characteristics as the pathological tissue, preferably the tumour, e.g. being secondary tumours. Thus, another aspect of the invention is a method of identifying pathological tissue, preferably tumour tissue using the methods described above.

In another preferred embodiment, the ROI defined in the image space from one or more patients corresponds to a given type of tumour and the methods of the invention are used to create a class model for said given type of tumour and/or identify image data (pixels) having similar properties/characteristics as the given type of tumour. Thus, another aspect of the invention is a method of identifying types of tumours using the methods described above.

In another preferred embodiment, the ROI defined in the image space from one or more patients corresponds to a tumour with a given tumour grade and the methods of the invention are used to create a class model for said tumour grade and/or classifying tumour grades. Thus, another aspect of the invention is a method of classifying tumour grades using the methods described above.

The methods according to the invention are especially suitable for whole-body scanning of patients as in an whole body scan, a large amount of data are acquired which have to be processed. In a preferred embodiment, a rolling table platform is used to position the patient during scanning, as described by J. Barkhausen, Radiology 220, 2001, 252-256. In a further preferred embodiment, the complete body of the patient is slid through the magnet to create a baseline scan. Thereafter, a MR contrast agent is administered and immediately after administration, the patient is scanned repeatedly preferably using an ultra-fast scan technique. The image data acquired are then analysed according to the methods of the invention. This preferred embodiment is especially useful to detect and localise metastases.

### DESCRIPTION OF THE FIGURES

FIG. 1: is a schematic illustration of a preferred embodiment of the invention. In step a) of this preferred embodiment of the invention, data are generated in an image space (4) by acquisition of multichannel (1) data in MR tomography of a patient having a tumour (3). A contrast agent has been administered to the patient and at least one subset of the channels of the multichannel data describes the dynamic behaviour of said contrast agent. In a second step b) PCA is performed on the image data by unfolding the original multichannel data to provide a two-dimensional matrix X. Each column of the matrix X provides all the data from each channel (i.e. the matrix having nv·nh rows where nv is the number of vertical pixels and nh is the number of horizontal pixels in each image) with the number of columns equalling to the number of channels. The data generated by PCA are presented in a score plot. In a third step c), a region of interest (ROI)_{I} (3) is selected within the tumour image and the region of interest in the score plot space (5) (ROI)_{S} which corresponds to (ROI)_{I} is determined in a forth step d). As other data points from the image corresponding to tissue having similar characteristics as tissue belonging to the region of interest will be found close to the (ROI)_{S} in score plot space regardless of their actual position in the image itself, relevant data points in connection with the (ROI)_{S} are selecting in a fifth step e). In a further preferred embodiment, a class model is created from at least a part of the data points belonging to (ROI)_{S} which is used to classify data points in the score plot space. In a final step f), the data points selected in step e) are mapped back into the image space thus identifying image data (pixels) having a property similar to that of (ROI)_{I}, e.g. being secondary tumours.

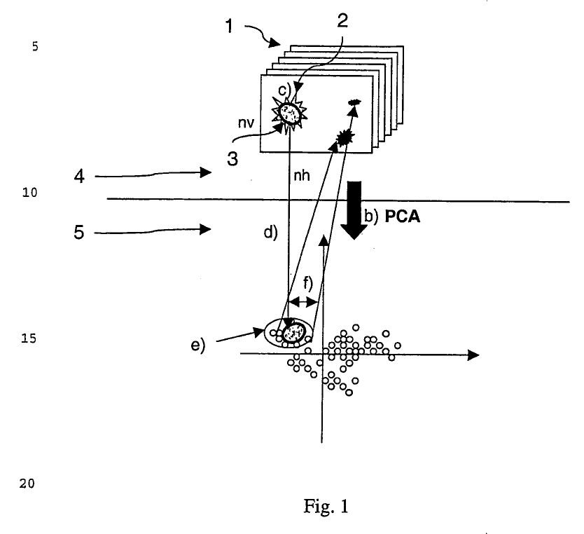

FIG. 2: relates to example 5 and shows a comparison between regions found by creating enhancement maps using the equation according to example 5 (left picture) and the method according to the invention (right picture).

### EXAMPLES

20 patients aged 57.0±12.3 years (mean ± standard deviation) with breast tumours were included in a study. Histopathology had detected satellite tumours in 7 patients, aged 50.3±6.7 years (mean ± standard deviation). These 7 patients had invasive ductal carcinoma or lobular carcinoma.

1.) Image Data Acquisition

Images were acquired at 1.5 T whole-body scanner (Edge EPI II, Picker, Cleveland, Ohio) using a commercially available, dedicated, receive-only double breast coil (Picker). The patients were examined in a prone position. Dynamic contrast-enhanced T₁-weighted images in the sagittal plane were acquired using a 3D rf-spoiled gradient-echo sequence (TR/TE/flip angle=9.0 ms/3.8 ms/30°) one average, field of view 250 mm, and an acquisition matrix of 128×256, 44 partitions corresponding to an effective slice thickness of 4 mm.

The 3D sequence was repeated continuously 9 times with a temporal resolution of 57 seconds; during the last 10 seconds of the acquisition of the third set of images, an intravenous bolus injection of 0.1 mmol/kg body weight gadodiamide (Omniscan™, Amersham Health, Oslo, Norway) was administered.

2.) Image Analysis

A software programme (MIAsoft) in Matlab was developed to perform the complete image analysis. Data in score plot space were generated from the image data using PCA. Subsequently, regions of interest were defined in the image space as well as in the score plot space using MIAsoft. In the image space, the regions of interest were positioned in the maximum enhancing regions of the tumours. Thereafter, corresponding regions of interest were determined in the image space and in the score plot space, respectively and relevant data points were selected in connection with the region of interest in the score plot space.

3.) Generation of Class Models

The SIMCA method was used to create a class model on the basis of one patient with known satellite tumour. The dimensionality of the class model was assessed by cross-validation. Data points were mapped back to the original images and pixels were highlighted that are classified to belong to the class. The classification was visually assessed by an experienced radiologist familiar with the material.

4.) Classification

a) Adjacent slices for the same patient were subjected to classification based on said class model. The results showed that this procedure classified pixels correctly (i.e. pathological findings concurred with the outcome of the classification) in other slices for the same patient. Almost no pixels were classified falsely as being part of a tumour.
b) The above-mentioned class model was then applied to the other patients. The method was successful in detecting all 7 known satellite tumours. In addition, the method indicated satellite tumours in 3 of the patients not known to have such satellite tumours. Results show that the tumours were found by classification of individual pixels, although in some cases the residuals were outside the critical limit. A possible explanation is that the image intensities vary from one patient to another, thus some histogram equalisation might be applied to improve the results.
   5.) Comparison with Traditional Classification Methods

A known formula for classifying breast tumours in dynamic contrast enhanced MR is:
E=100(Ia−Ib)/Ib
where
E is the enhancement factor
Ia is the intensity in the channel which show a peak image for a typical malignant tumour, and
Ib is the intensity in a channel of a pre-contrast image

Typically, enhancement above a certain threshold, like 80% or 100% is considered malignant.

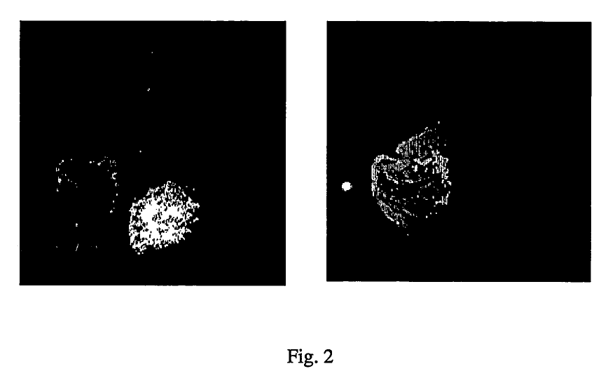

Compared to creating enhancement maps using the above equation, the PCA method showed to be much more specific. Signals from the heart were in most cases completely masked out and the location and size of the tumours were well visualised. These results are shown in FIG. 2, which shows a comparison between regions found by creating enhancement maps using the above equation (left picture) and the PCA method according to the invention (right picture).

1. Method of analysing image data comprising
a) generating data in an image space by acquisition of multichannel data in MR tomography of an human or non-human animal body where at least one subset of the channels describes the dynamic behaviour of a MR contrast agent which has been previously administered to said body,
b) defining a least one region of interest in the image space (ROI)_{I},
c) generating data in a score plot space by transforming the image data generated in a) or data corresponding to (ROI)_{I} into score plot data using multivariate image analysis,
d) determining the region of interest in the score plot space (ROI)_{S} which corresponds to (ROI)_{I},
e) selecting relevant data points in connection with the (ROI)_{S}, and
f) mapping the data points selected in e) into an image space and thereby identifying image data having properties similar to that of (ROI)_{I}.

2. Method according to claim 1, wherein the MR contrast agent is a blood pool MR contrast agent.

3. Method according to claim 1 wherein the MR contrast agent is an ECF MR contrast agent

4. Method according to claim 1, wherein the multivariate image analysis is carried out with bilinear methods or multi-way extensions of bilinear methods.

5. Method according to claim 1, wherein mulitvariate image analysis is carried out using principal component analysis (PCA) or partial least squares regression (PLSR).

6. Method according to claim 1, wherein noise reduction methods and/or methods for motion estimation are applied to the data acquired in step a)

7. Method according to claim 1, wherein in step c) data in a score plot space are generated by transforming the image data corresponding to (ROI)_{I}.

8. Method according to claim 1, wherein data in the score plot belonging to the (ROI)_{S} are used to create a class model.

9. Method according to claim 8, wherein data in the score plot space belonging to the (ROI)_{S} are validated, preferably by unsupervised cross validation or jack-knifing.

10. Method according to claim 8, wherein the class model is used for the classification of data points in the score plot space.

11. Method according to claim 10, wherein the classification is carried out using soft independent modelling of class analogies (SIMCA).

12. Method claim 1, for the identification of pathological tissue, preferably tumour tissue.

13. Method according to claim 1, for the classification of tumours and/or for the classification of tumour grades.

14. Method of analysing image data comprising
a) generating data in an image space by acquisition of multichannel data in MR tomography of a human or non-human animal body where at least one subset of the channels describe the dynamic behaviour of a MR contrast agent which has been previously administered to said body,
b) generating data in a score plot space by transforming the image data generated in a) into score plot data using multivariate image analysis
c) defining at least one region of interest in the score plot space (ROI)_{S} and
d) determining the region of interest in the image space (ROI)_{I} which corresponds to (ROI)_{I}.
